(19) United States
(12) Patent Application Publication
(10) Pub. No.: US 2011/0000772 A1
(43) Pub. Date: Jan. 6, 2011

(54) POWER SWITCHGEAR

(75) Inventors: Masahiro Hanai, Kanagawa-ken (JP); Haruhisa Wada, Kanagawa-ken (JP); Shiro Maruyama, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Minato-ku (JP)

(21) Appl. No.: 12/445,943

(22) PCT Filed: Oct. 15, 2007
(86) PCT No.: PCT/JP2007/070069

§ 371 Date: Apr. 17, 2009

(30) Foreign Application Priority Data
Oct. 17, 2006 (JP) 2006-282944

(51) Int. Cl. H01H 9/00

(52) U.S. Cl. 200/308

(57) ABSTRACT

A power switchgear having an action monitoring function by an IC tag with a sensor includes: a main body including a switching section carrying out switching action; an operating mechanism including a switching operation section mechanically connected to the switching section so as to carry out switching operation of the switching section; and an action monitoring section monitoring an action of the switching operation section and wirelessly communicating with an external equipment. The action monitoring section includes an IC tag with sensor attached to a portion of the switching operation section and a case surrounding at least a portion of the switching operation section including the IC tag with a sensor.

### TECHNICAL FIELD

The present invention relates to a power switchgear, such as a gas insulation switchgear, and especially, it relates to a power switchgear having an action monitoring function by an IC tag with a sensor for a purpose of detecting and monitoring a state of switching action.

### BACKGROUND ART

Generally, a breaker used as a power switch is provided with an auxiliary switch at an operating mechanism section thereof, in order to display a state of switching action of a breaking section or to measure the switching action time of the breaking section thereof. The auxiliary switch includes a-contact point and b-contact point that switch in conjunction with the switching action of the operating mechanism of the breaker.

However, since the auxiliary switch is driven by the mechanical a-contact point and b-contact point, sometimes, the action tends to be unstable due to wearing of the contact points and foreign materials adhering to the contact points accompanied with increase of cumulative times of switching action.

Thus, in recent years, instead of a conventional auxiliary switch, a contactless proximity type sensor for detecting a switching action state of the breaker has been used. As such a type of sensor, for example, there is a sensor utilizing a high frequency oscillation.

FIG. 8 is a longitudinal sectional view illustrating an example of a conventional power switch (puffer-type gas circuit breaker 100) having an action monitoring function and including a sensor utilizing a high frequency oscillation.

As illustrated in FIG. 8, the conventional puffer-type gas circuit breaker 100 has a main body in a sealed case 102 in which an insulating gas such as an SF₆ gas is enclosed, where, as a switching section, a fixed electrode 103 and a movable electrode 104 are arranged in a relatively movable manner, and a puffer mechanism 105 is additionally formed at the side of the movable electrode 104. Further, this puffer-type gas circuit breaker 100 is configured so as to spray the insulating gas compressed by the puffer mechanism 105 against an ark generated between the both electrodes 103 and 104 to extinguish the ark, at the time of switching action of the both electrodes 103 and 104.

Switching action of the movable electrode 104 of the puffer-type gas circuit breaker 100 is carried out by the up-and-down action of an operating piston 109 of an operating mechanism 108 which is connected to the electrode 104 through an insulating rod 106 and an operating rod 107 as a switching operation section. That is, by opening a drawing-out valve 112 of a hydraulic system including an accumulator 110 and an oil pump 111, the operating piston 109 of the operating mechanism 108 is moved downward to draw out the movable electrode 104 from the fixed electrode 103, and by opening a drawing-in valve 113, the piston 109 is moved upward to draw the movable electrode 104 into the fixed electrode 103.

In addition, in the puffer-type gas circuit breaker 100, an action monitoring unit 114 for detecting a switching action state is provided in the operating mechanism 108. The action monitoring unit 114 includes: a monitoring case 115 surrounding a part of the operating rod 107; a position detector 116 provided to a moving portion of the operating rod 107 in a fixed manner in the monitoring case 115; two sensors 117a and 117b provided to the monitoring case 115 with penetrating through the side wall of the case 115 and facing the position detector 116; and a sensor attaching plate 118 fixed to the external surface of the monitoring case 115 and to which the sensors 117a and 117b are attached. In this case, the position detector 116 is constructed by, for example, a metal flange connecting the operating rod 107 and the piston rod of the operating piston 109.

Moreover, the two sensors 117a and 117b have a position detection function to detect the position of the position detector 116 using a high frequency oscillation. That is, the two sensors 117a and 117b utilizing a high frequency oscillation utilize an event that, if a metal, which is a detection target, approaches to an oscillation coil that is sensitive to approach, the oscillation of the coil is stopped due to self inductance change and loss change of a sensor circuit, and they are constructed to be sensitive to approach of the position detector 116 so as to detect the position of the detector. When the movable electrode 104 of the puffer-type gas circuit breaker 100 and the operating rod 107 connected to this circuit breaker 100 are in an open or closed state, the sensors 117a and 117b are configured so as to detect an open or closed position of the position detector 116 provided to the operating rod 107 to generate an open or closed position signal.

In addition, the outputs of the sensors 117a and 117b are usually configured to be transmitted to a sensor receiver stored in a relay board or a measurement section etc. which are not illustrated, through cables 119a and 119b, such as twisted pair wires.

The output signals from the sensors 117a and 117b of the action monitoring unit of the above-mentioned conventional power switch are an open position signal and a closed position signal. They are very effective for externally displaying any one of the open state and the closed state. On the contrary, when the switch is diagnosed by observing the state in the midway of its action, only the time during changing from the open state to the closed state or the time during changing from the closed state to the open state can be observed. Since there is fluctuation of switching action in the measurement of these times only, the switch cannot be diagnosed by the time required for only one switching action, and it is necessary to observe the trend of times required for multiple times of switching actions.

In order to measure this trend, if not only the time of the switching action but also a relationship (a stroke curve) between the past time of the action and the position is measured, even if a problem, such as delay in the midway of the action, is occurred, the trend can be determined immediately. However, in order to measure the stroke curve, it is necessary to determine the correlation between voltage and position by arranging a winding, a resistor, or the like, near the operating rod 107 and applying a voltage in advance. In this configuration, if an electrode is attached to the operating rod 107 so as to contact the winding or the resistor, the relationship between voltage (position) and time, measured by the electrode attached to the operating rod 107, can be observed as a stroke curve. However, in order to measure the stroke curve, since, it is necessary to place a winding or a resistor to which a voltage is applied and to attach a wiring to the operating rod 107 while adjusting the electrode, in a usual state, there are drawbacks of not only a very complicated procedure, but also in that the measuring system cannot be left attached to the switch due to its lower reliability than that of the switch. For this reason, usually, even for a factory test or a field, the measurement can be carried out only once every several years at a periodic check.

In order to solve the problem, by using a ultrasonic wave sensor and adopting the configuration for transmitting an output depending on the travel distance of the position detector, it is possible to know the action states of the power switchgear and the sensor itself from the transmitted output, easily and surely, and it is possible to provide a power switchgear with improved reliability. The power switchgear having such a configuration is disclosed in, for example, Japanese Patent Laid-Open No. H07-288068. This power switchgear has a self monitoring function of the sensor and has higher reliability than that of a type of power switchgear using a high frequency.

However, it was necessary for a conventional device and a method using a high frequency or ultrasonic wave to transmit a signal from the sensor to an external storage device through a wire, since not only complicated wiring work is required, but also even a switchgear that operates less frequently requires an switchgear device to be attached, this was not an economical (inexpensive) way.

### DISCLOSURE OF THE INVENTION

The present invention is proposed for the purpose of solving the above-mentioned problems of a conventional technology, and an object thereof is to provide an inexpensive power switchgear which can measure a switching action by measuring the action state of an operating rod etc. including time information, can easily and surely determine the presence of anomaly, and can attain an action monitoring function more reliable than ever.

In order to solve the above-mentioned problems, a power switchgear having an action monitoring function by an IC tag with a sensor according to the present invention, includes:

a main body of a power switchgear including a switching section carrying out an switching action;

an operating mechanism including a switching operation section mechanically connected to the switching section to carry out a switching operation of the switching section; and

an action monitoring section monitoring an action of the switching operation section and wirelessly communicating with external equipment,

wherein the action monitoring section includes an IC tag with a sensor attached to a portion of the switching operation section and a case surrounding at least a portion of the switching operation section including the IC tag with a sensor.

In a preferred embodiment of the power switchgear, it is preferable for the power switchgear to have the following aspects.

The IC tag with a sensor includes a storage medium recording a measurement result acquired by the sensor of the IC tag with a sensor.

The sensor of the IC tag is a strain sensor having a strain detecting function. The strain sensor detects the strain amount of the switching operation section based on the measurement result of a resistance value of an antenna of the IC tag with a sensor.

The IC tag with a sensor includes a power supply unit, such as, for example, a battery or a large capacitance capacitor, which supplies a power to actuate the IC tag with a sensor, and the power supply unit has a charging function to be wirelessly charged from the outside.

The IC tag with a sensor has an own antenna used as a magnetic field sensor.

The case of the action monitoring section includes a magnet which is placed so as to pass through the neighboring of the IC tag with a sensor at the time of being moved by the operation of the switching operation section.

The magnet is provided with N- and S-poles having fine pitch polarities arranged alternately.

According to the present invention, in which the IC tag with a strain sensor is attached to an operating rod for the switching action so as to store in a storage unit the detection result and detection time of strain occurred in the operating rod and to transmit the stored information (detection result and detection time) to an IC tag reader, it is possible to grasp the action state of the power switchgear easily and surely, and accordingly, a power switchgear having reliability higher than ever can be provided.

### BRIEF DESCRIPTION OF THE DRAWINGS

FIG. 1 is a longitudinal (vertical) sectional view of an example of a power switchgear (puffer-type gas circuit breaker) having an action monitoring function by an IC tag with a sensor according to a first embodiment of the present invention.

FIG. 2 is an enlarged sectional view illustrating a configuration of an action monitoring section of the power switchgear having the action monitoring function by the IC tag with a sensor according to the first embodiment of the present invention.

FIG. 3 is a schematic view schematically illustrating a configuration of an IC tag with a sensor of the power switchgear according to the present invention and an IC tag reader wirelessly communicating with the IC tag with a sensor.

FIG. 4 is an explanatory view describing an example of the configuration of information stored in the IC tag with a sensor of the power switchgear according to the present invention.

FIG. 5 is a longitudinal (vertical) sectional view of an example of a power switchgear (puffer-type gas circuit breaker) having an action monitoring function by an IC tag with a sensor according to a second embodiment of the present invention.

FIG. 6 is a longitudinal sectional view of a magnet used for an example of the power switchgear (puffer-type gas circuit breaker) having an action monitoring function by the IC tag with a sensor according to the second embodiment of the present invention.

FIG. 7 is a schematic view schematically illustrating another configuration of the IC tag with a sensor of the power switchgear according to the present invention.

FIG. 8 is a longitudinal (vertical) sectional view of a puffer-type breaker that is an example of a power switchgear having a conventional action monitoring unit.

### BEST MODES FOR CARRYING OUT THE INVENTION

Hereinafter, with reference to the accompanying drawings, best modes (embodiments) for implementing a power switchgear having an action monitoring function by an IC tag with a sensor according to the present invention, will be described. Further, it is to be noted that, in the following description, there will be described a case, as one example, in which a power switchgear having an action monitoring function by an IC tag with a sensor is a puffer-type gas circuit breaker.

### First Embodiment

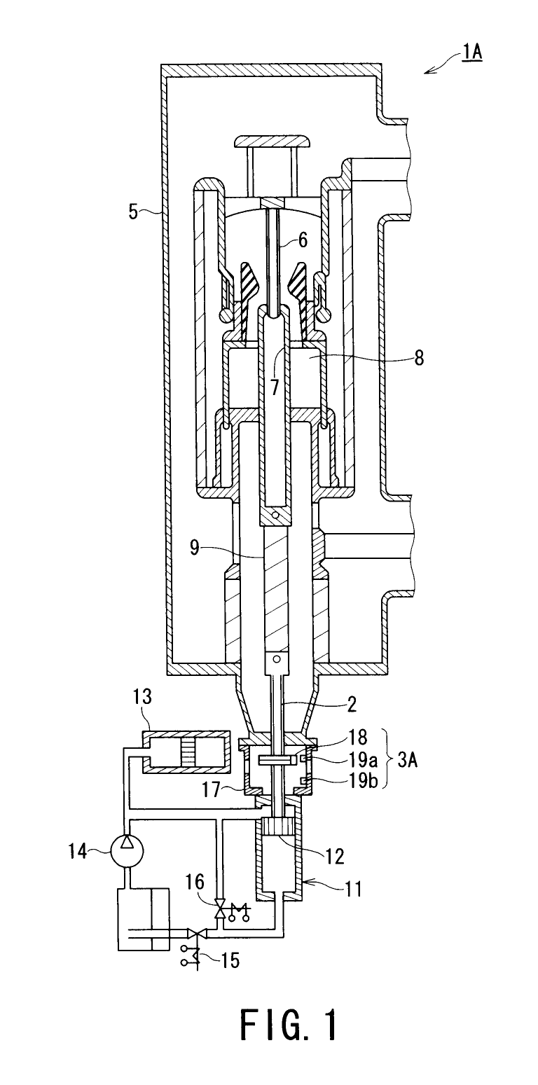

FIG. 1 is a longitudinal sectional view illustrating an configuration of puffer-type gas circuit breaker (hereinafter, which may simply be abbreviated as a breaker) 1A having an action monitoring function by an IC tag with a sensor that is an example of a power switchgear having an action monitoring function by an IC tag with a sensor according to a first embodiment of the present invention.

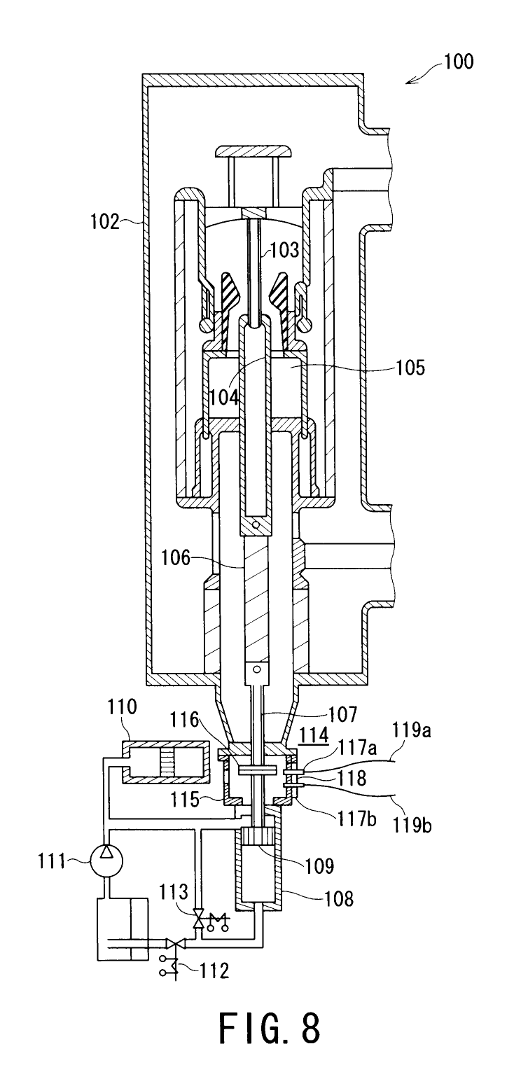

As illustrated in FIG. 1, the breaker 1A includes an action monitoring section 3A having an action monitoring function monitoring the action state of an operating rod 2. Further, it is to be noted that a configuration necessary for carrying out a breaking action is the same as that of a conventional puffer-type breaker 100 illustrated in FIG. 8.

That is, in the breaker 1A, as a switching section, a fixed electrode 6 and a movable electrode 7 are arranged in a relatively movable manner inside a sealed case 5 in which an insulating gas such as an SF₆ gas is enclosed, and the breaker 1A includes a device main body section in which a puffer mechanism 8 is additionally formed at the side of the movable electrode 7, and also includes an operating mechanism 11 connected to the main body through an insulating rod 9 and an operating rod 2 as a switching operation section.

The switching action of the movable electrode 7 of the breaker 1A is carried out by an up-and-down action of an operating piston 12 of the operating mechanism 11 connected through the insulating rod 9 and the operating rod 2. That is, the operating piston 12 of the operating mechanism 11 is configured so as to be moved downward by opening a drawing-out valve (breaking valve) 15 of a hydraulic system including an accumulator 13 and an oil pump 14 to draw the movable electrode 7 out from the fixed electrode 6, and so as to be moved upward by opening a drawing-in valve 16 to draw the movable electrode 7 into the fixed electrode 6. The breaker 1A is configured so as to spray the insulating gas compressed by the puffer mechanism 8 against an ark generated between the both electrodes 6 and 7 to extinguish the ark, at the time of switching action of the both electrodes 6 and 7.

In the breaker 1A, the action monitoring section 3A detecting a state of a switching action is mounted to the operating mechanism 11. The action monitoring section 3A includes a monitoring case 17 surrounding a part of the operating rod 2, an IC tag with a strain sensor having a strain detecting function (hereinafter, referred to as an IC tag 18 with a strain sensor), and magnets 19a and 19b inducing a magnetic field.

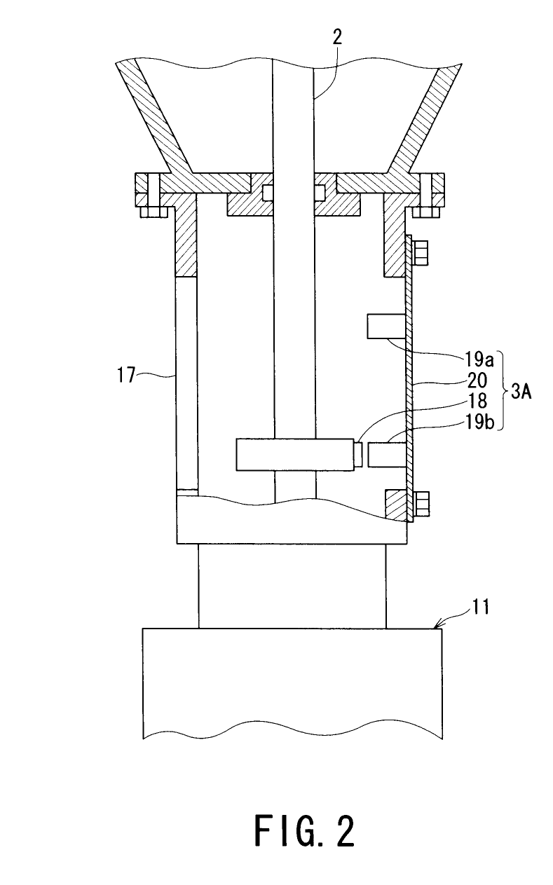

FIG. 2 is an enlarged schematic view illustrating a configuration of the action monitoring section 3A of the breaker 1A that is an example of a power switchgear having an action monitoring function by an IC tag with a sensor according to the first embodiment of the present invention.

As illustrated in FIG. 2, the IC tag 18 with a strain sensor is detachably attached to the operating rod 2 so as not to be removed from the operating rod 2 when the breaker 1A is actuated. The magnets 19a and 19b inducing a magnetic field in a direction perpendicular to the direction of the action of the operating rod 2 are attached to the wall surface of the monitoring case 17 surrounding a part of the operating rod 2.

The magnet 19a is placed at a position facing the IC tag 18 with a strain sensor when the breaker 1A is closed, and the magnet 19b is placed at a position facing the IC tag 18 when the breaker 1A is opened. Moreover, in order to fix the magnets 19a and 19b to the wall surface of the monitoring case 17, a magnet attaching plate 20 is fixed to the outer surface of the monitoring case 17.

Next, the outline of an action of the breaker 1A including the action monitoring section 3A as illustrated in FIG. 2, will be described.

If the operating rod 2 is slid up-and-down while being applied with a force by the switching action of the breaker 1A, it will be interlinked with the magnetic fields of the magnets 19a and 19b, and an electric power will be generated at the antenna portion of the IC tag 18 with a strain sensor attached to the operating rod 2. That is, the antenna portion of the IC tag 18 with a strain sensor functions as a magnetic field sensor.

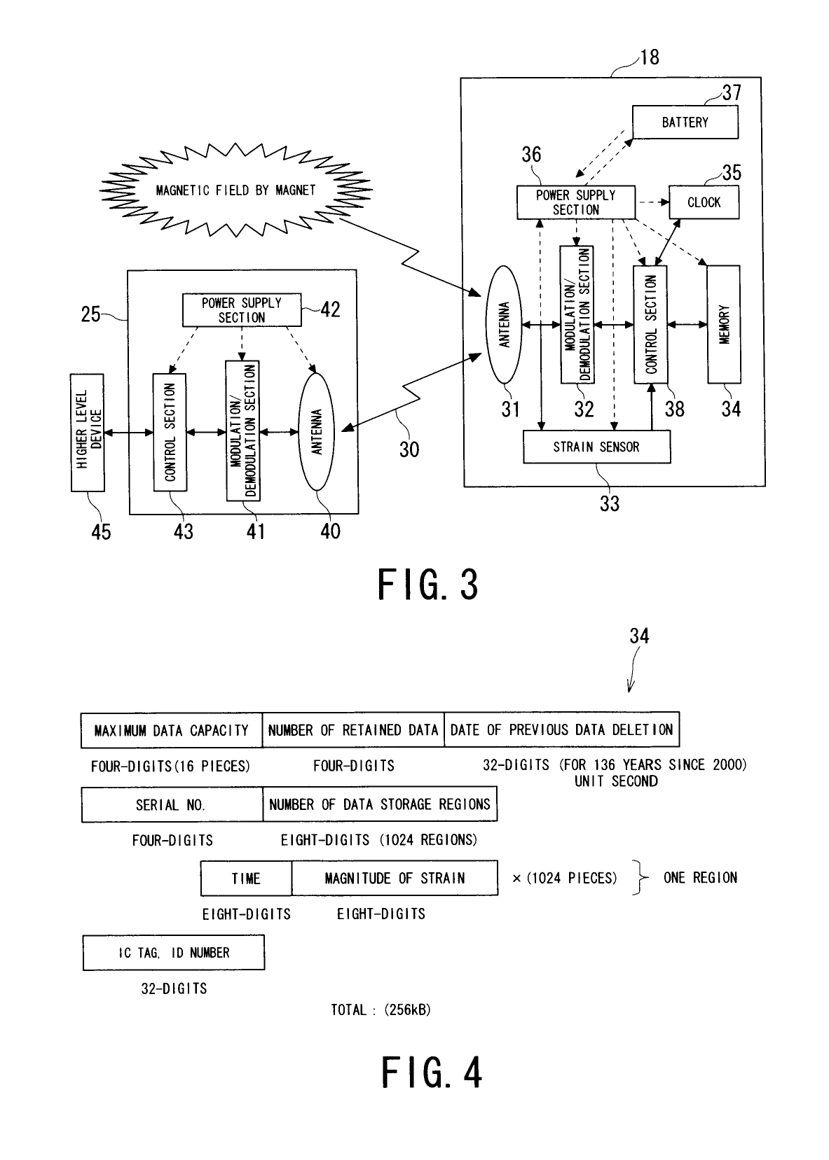

With occurrence of the power at the antenna portion of the IC tag 18 with a strain sensor as a trigger, the IC tag 18 with a strain sensor stores data acquired by the strain sensor of the IC tag 18 with a strain sensor together with the time. The data stored in the IC tag 18 with a strain sensor can be acquired by reading from an IC tag reader 25 illustrated in FIG. 3 to be described later.

FIG. 3 is a schematic view illustrating a schematic configuration of the IC tag 18 with a sensor of the power switchgear according to the present invention and the IC tag reader 25 that wirelessly communicates with the IC tag 18 to read information from the IC tag 18. In addition, in FIG. 3, solid lines and dotted lines in the IC tag 18 and the IC tag reader 25 represent flows of information and energy, respectively.

As illustrated in FIG. 3, the IC tag 18 with a sensor includes: an antenna 31 transmitting/receiving an electromagnetic wave including a signal and information (hereinafter, simply referred to as a communication signal) 30 to/from the IC tag reader 25, to communicate with the IC tag reader 25; a modulation/demodulation section 32 for modulating/demodulating the electromagnetic wave received through the antenna 31; a strain sensor 33 detecting and acquiring the strain amount as an example of a sensor; a memory 34 storing the information acquired by the strain sensor 33; a timer built-in clock 35; a power supply section 36 supplying operating power; a battery 37 supplying power to the power supply section 36; and a control section 38 controlling the IC tag 18.

The modulation/demodulation section 32 has a function of converting the transmitted/received signal 30 so as to be suitable for being recorded, transmitted or the like (a modulation function and a demodulation function), and a function of filtering the communication signal 30, and can remove noise components due to a partial discharge etc. superimposed on the communication signal 30. The strain sensor 33, based on the result of measuring resistance value of the antenna 31, detects the strain amount of the operating rod 2 as a switching operation section. The memory 34 is, for example, a storage medium composed of a nonvolatile memory. The control section 38 has information necessary for control, such as information with regard to an information storage procedure of the memory 34, and executes arithmetic processing.

Further, an active type IC tag having a built-in battery 37 is used as an example of the IC tag 18 with a sensor. Thus, it is premised that the IC tag 18 with a sensor itself is replaced periodically before the battery 37 dies, and therefore, the IC tag 18 is usually configured not to transmit information such as measurement results, unless it receives a reading signal from the IC tag reader 25.

On the other hand, the IC tag reader 25 includes: an antenna 40 for transmitting/receiving the communication signal 30 to/from the IC tag 18; a modulation/demodulation section 41 for modulating/demodulating an electromagnetic wave received through the antenna 40; a power supply section 42 for supplying operating power, and a control section 43 for controlling the IC tag reader 25.

Furthermore, the IC tag 18 with a sensor and the IC tag reader 25 perform frequency modulation or digital modulation on an electromagnetic wave and transmit/receive various kinds of signals such as a data reading start command signal and measurement results. This operation facilitates the distinguishing of a necessary signal or necessary information from noises due to a partial discharge etc.

Moreover, the antenna 40, the modulation/demodulation section 41, the power supply section 42, and the control section 43 of the IC tag reader 25 are components having substantially the same action as that of the antenna 31, the modulation/demodulation section 32, the power supply section 36, and the control section 38 of the IC tag 18 with a sensor, respectively.

The IC tag reader 25 wirelessly communicates with the IC tag 18 by transmitting the read signal 30 thereto and can read information therefrom. The measurement data received to the IC tag reader 25 from the IC tag 18 is input into a higher level device 45, such as a computer, through a cable or a removable storage memory.

FIG. 4 is an explanatory view describing an example of a configuration of information stored in the memory 34 of the IC tag 18 with a sensor.

In an example of the information stored on the memory 34, as illustrated in FIG. 4, pieces of information, such as maximum data capacity, the number of retained data, date of previous data deletion, a serial number (No.), the number of data storage regions (for example, 1024 regions), and identification information of an IC tag (an ID number of the IC tag), are included.

For a case of the memory 34 of the IC tag 18 with a strain sensor included in the action monitoring section 3A illustrated in FIG. 1, the strain sensor is related to one serial number, and a measurement result of the strain amount and the corresponding measurement time are stored in one data storage region corresponding to the serial number. For a case of the memory 34 illustrated in FIG. 4, since 1024 measurement results can be stored on one data storage region, if all of the 1024 data storage regions are used, 1024×1024 pieces of data can be stored.

Next, the action of the power switchgear having an action monitoring function by the IC tag with a sensor according to the first embodiment of the present invention, will be described, in a case of the breaker 1A, as an example.

First, at the time of switching action of the breaker 1A, the IC tag 18 detects time and strain occurred at the operating rod 2 with a strain sensor 33 and acquires information of the strain amount.

In the IC tag 18 with the strain sensor, as illustrated in FIG. 3, the control section 38 stores information of the strain amount that is detected by the strain sensor 33 for every predetermined times by the action of a timer built in the clock 35, together with time information (for example, time) in the memory 34. Thus, on the memory 34, transition of the strain amount over time is stored.

Here, in a case where, as the result of storing measurement results on the memory 34, if newly acquired information of the strain amount is stored thereon, capacity of the memory 34 is exceeded, and the control section 38 controls the memory 34 so as to store information of the strain amount according to a predetermined rule. For example, in a case where 1024 (the maximum number) measurement results of the strain amount are stored, the control section 38 deletes the oldest measurement result of the strain amount in the data storage region where measurement results data of the strain amount are stored and stores a newly measured result of the strain amount thereon.

As an example illustrated in FIG. 4, when the identification information of an IC tag (an ID number of the IC tag) is stored on the memory 34, the IC tag reader 25 allows the strain amount (information of measurement results) stored on the memory 34 to be read, if one or both of the identification information of an IC tag and the identification information of the IC tag reader 25 are coincided with each other.

That is, if the IC tag reader 25 gives the high frequency signal (communication signal) 30 to the IC tag 18 with a strain sensor by an electromagnetic wave from the outside of the breaker 1A, the IC tag 18 can transmit/receive the information to/from the IC tag reader 25. Since the information of the measurement result of the strain amount acquired by the IC tag 18 with a strain sensor can thus be acquired by a remote operation for transmitting the communication signal 30 from a distant place, a user can measure and monitor the strain amount without changing the state of the breaker 1A.

According to the breaker 1A (power switchgear having an action monitoring function by an IC tag with a sensor according to the first embodiment of the present invention), at the time of monitoring the action of the operating rod 2 in switching action, change of magnetic fluxes generated by the movement of the operating rod 2 triggers activation of the IC tag 18 with a strain sensor to thereby store the strain occurred by the movement of the operating rod 2 on the memory 34 of the IC tag 18 with a strain sensor. Thus, during the continuous detection, the trend of the switching action can be recorded without requiring a special power source.

Moreover, if an electromagnetic wave for data communication that is radiated from the IC tag reader 25 to the IC tag 18 with a strain sensor and superimposed on time information, is received by the IC tag 18 with a strain sensor through the antenna 31, the control section 38 acquires the time information superimposed on the electromagnetic wave through the antenna 31 and the modulation/demodulation section 32 and can correct the time by generating a correction signal of the clock 35 based on the acquired time information. It is therefore possible to correct the time of the clock 35 at every time when the IC tag reader 25 transmits an electromagnetic wave to read/write information.

At the time of transmission of a start command signal from the IC tag reader 25 to the IC tag 18 in reading and data transmission from the IC tag 18 to the IC tag reader 25, an electromagnetic wave is subjected to frequency modulation or digital modulation, and therefore, it is possible to facilitate the distinguishing of a signal and data read/written between the IC tag reader 25 and the IC tag 18 from noises due to a partial discharge etc.

### Second Embodiment

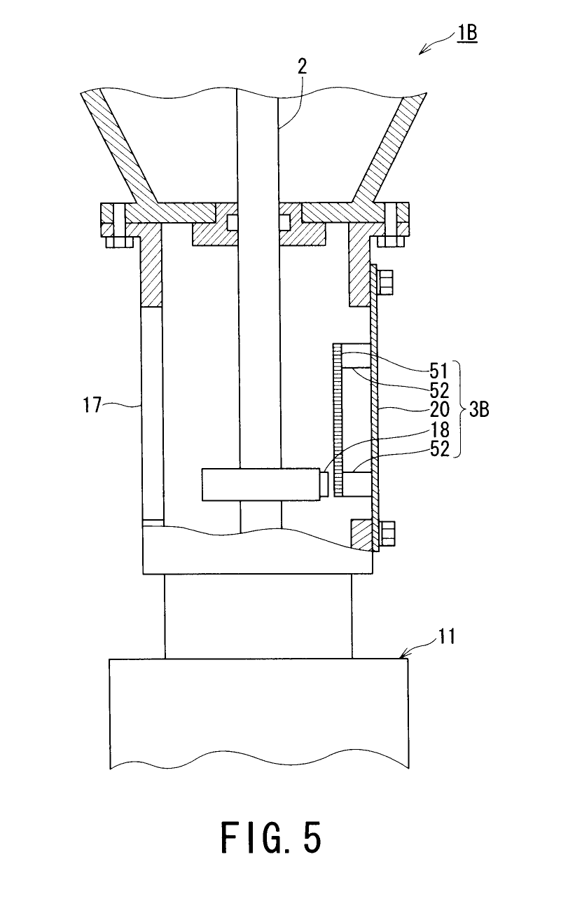

FIG. 5 is an enlarged schematic view of the configuration of an action monitoring section 3B of a breaker 1B that is an example of a power switchgear having an action monitoring function by an IC tag with a sensor according to a second embodiment of the present invention.

Although the breaker 1B, which has an action monitoring function by an IC tag with a strain sensor as an example of a power switchgear having an action monitoring function by an IC tag with a sensor according to the second embodiment of the present invention, differs from the breaker 1A of the first embodiment in that the action monitoring section 3B is provided instead of the action monitoring section 3A, there is substantially no difference between the breakers 1A and 1B with respect to other points. Thus, in the description of the second embodiment, same reference numerals are denoted to the same components as those of the breakers 1A, and description thereof will be omitted.

Although the action monitoring section 3B differs from the action monitoring section 3A in that the action monitoring section 3B has a magnet 51 instead of magnets 19a and 19b, there is substantially no difference between the action monitoring section 3B and the action monitoring section 3A with respect to other points. That is, the action monitoring section 3B includes a monitoring case 17, an IC tag 18 with a strain sensor and the magnet 51. Further, in the action monitoring section 3B illustrated in FIG. 3, although the magnet 51 is attached through a magnet attaching base 52 attached to a magnet attaching plate 20, it may be directly attached to the magnet attaching plate 20 in the same manner as that in the case of the magnets 19a and 19b of the action monitoring section 3A illustrated in FIG. 2.

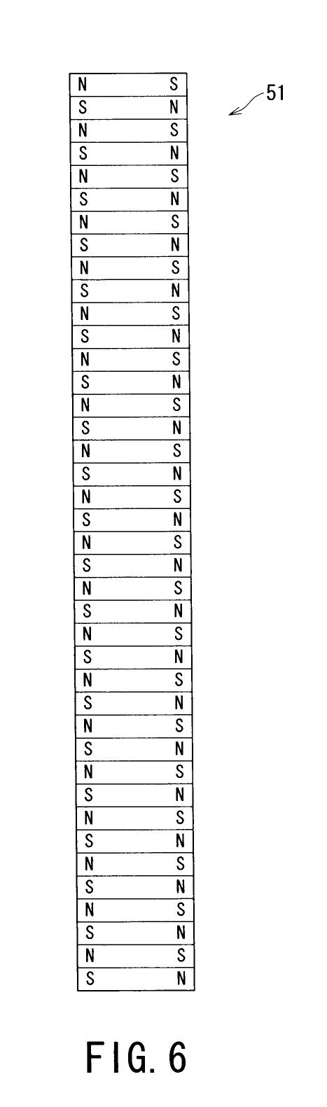

FIG. 6 is an explanatory view illustrating the configuration of the magnet 51 included in the action monitoring section 3B.

As illustrated in FIG. 6, in the magnet 51, fine pitch polarities of an N-pole and an S-pole are alternately arranged. If the magnet 51 having such polarity arrangement is used, when the switching operation of the breaker 1B is performed, the antenna 31 of the IC tag 18 with a strain sensor repeats interlinkages with magnetic flux corresponding to the fine pitch of the magnet 51.

As a result, the voltage frequency of a generated AC corresponds to a moving distance, and the time for one cycle corresponds to the speed thereof. Accordingly, the stroke of the switch can be calculated using not only the output of the strain sensor 33 but also the output received from the antenna 31, and it is therefore possible to carry out more detailed diagnosis. In addition, other actions and effects of the breaker 1B are the same as those of the above-mentioned breaker 1A.

As mentioned above, according to the power switchgear having the action monitoring function by an IC tag with a sensor according to the present invention, the strain generated by the switching action can be easily and surely detected by attaching the IC tag 18 to the power switchgear. The data detected by the IC tag 18 with a strain sensor can be easily transmitted to the IC tag reader 25 from the antenna 31 of the IC tag 18 through a radio wave (communication signal) 30. Accordingly, by comparing the trends of the measured results, an abnormal action of the switchgear can be found at a time of a periodic check, not only facilitating diagnosis, but also enabling continuous monitoring.

Moreover, with regard to the information stored on the memory 34, since it is possible for the data in the switching action recorded on the memory 34 until now to be read by transmitting the reading signal 30 from the IC tag reader 25, the relationship between the time of the switching action and the applied stress can be known, thus enabling every switching actions to be compared each other. As a result, it is possible to determine whether the relationship between the time of the switching action and the applied stress has been changed quickly or slowly, thus also enabling the abnormal state of the power switchgear to be diagnosed in detail.

Further, although, in the above described embodiments, there were explained the examples in which the action of the switching operation section is detected, using magnets 19a and 19b, or 51, based on the strain amount of the operating rod 7, the specific configuration of the magnet can be selected in any way depending on the position detection mode of the switching operation section, and the position with respect to the IC tag 18 with a strain sensor can also be set in any way.

Moreover, it is possible to detect the position of the switching operation section are not used even if the magnets 19a and 19b, or 51. For example, if an IC tag with an acceleration sensor is used, it is possible to detect the action of the switching operation section directly.

On the other hand, it is not necessary for the IC tag 18 with a strain sensor to be provided to the operating rod 2, instead, it can be placed to any position of the operation portion operating the switching section of the power switchgear. Moreover, the specific configuration of the IC tag 18 with a strain sensor can be changed suitably.

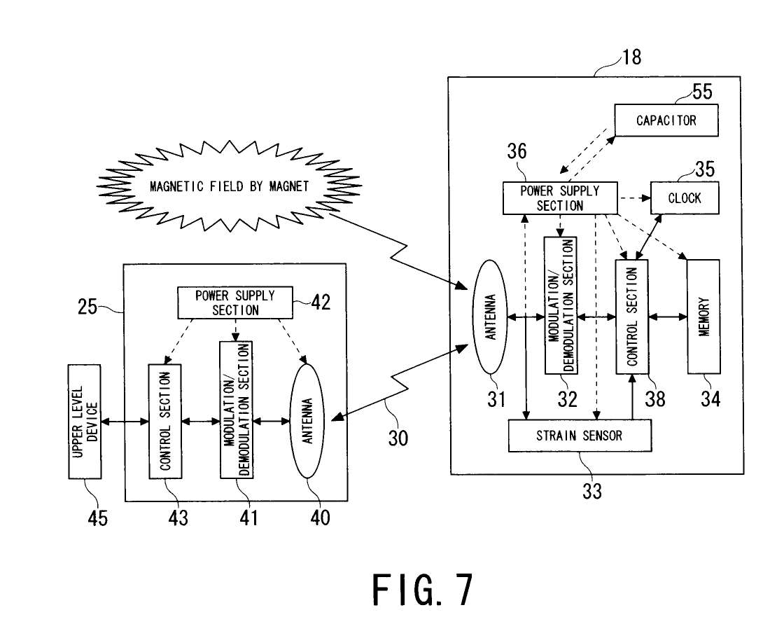

In addition, although in the above-described embodiments, there were described the examples in which the IC tag 18 with a sensor is an active type IC tag including the battery 37, the IC tag 18 may be a passive type IC tag including a charging device. When the passive type IC tag 18 including a charging device is adopted, a charging function can be achieved by radiating an electromagnetic wave to charge the battery periodically to the tag from the outside. Moreover, instead of the battery 37, a high-speed chargeable accumulator battery, or a high capacitance capacitor 55, such as, for example, an electric double layer capacitor as illustrated in FIG. 7, may be included. In these cases, since they can be charged by being irradiated with an electromagnetic wave periodically from the outside, similar actions and effects to those of the battery 37 may also be attained.

Furthermore, although in the above-described embodiments, there were also described the examples in which the power switch is a puffer-type gas circuit breaker, the present invention is also applicable to a general power switchgear including a switching section, similarly. For example, even if the tag is attached to an operating rod such as a tap changer of a transformer, similar actions and effects can be attained.

It is further to be noted that the present invention is not limited to the modes described in the above-mentioned embodiments, and many changes and modifications may be made without departing from the subjects or scopes of the present invention and claims mentioned hereinafter.

1. A power switchgear comprising:
a main body of a power switchgear including a switching section carrying out switching action;
an operating mechanism including a switching operation section mechanically connected to the switching section so as to carry out a switching operation of the switching section by an action of the operating mechanism; and
an action monitoring section monitoring an action of the switching operation section and wirelessly communicating with an external equipment,
wherein the action monitoring section includes an IC tag with a sensor attached to a portion of the switching operation section and a case surrounding at least a portion of the switching operation section including the IC tag with a sensor.

2. The power switchgear according to claim 1, wherein the IC tag with a sensor includes a storage medium recording a measurement result acquired by the sensor of the IC tag with a sensor.

3. The power switchgear according to claim 1, wherein the sensor of the IC tag is a strain sensor having a strain detecting function.

4. The power switchgear according to claim 3, wherein the strain sensor detects a strain amount of the switching operation section, based on a measurement result of a resistance value of an antenna of the IC tag with a sensor.

5. The power switchgear according to claim 1, wherein the IC tag with a sensor includes a power supply unit supplying a power to actuate the IC tag with a sensor, and the power supply unit has a charging function to be wirelessly charged from outside.

6. The power switchgear according to claim 5, wherein the power supply unit is composed of a battery.

7. The power switchgear according to claim 5, wherein the power supply unit is composed of a capacitor.

8. The power switchgear according to claim 1, wherein the IC tag with a sensor has an own antenna used as a magnetic field sensor.

9. The power switchgear according to claim 1, wherein the case of the action monitoring section is mounted with a magnet, which is arranged so as to pass through neighboring of the IC tag with a sensor during movement by an operation of the switching operation section.

10. The power switchgear according to claim 9, wherein the magnet is provided with N- and S-poles having fine pitch polarities arranged alternately.
